(19) United States
(12) Patent Application Publication
(10) Pub. No.: US 2018/0069993 A1
(43) Pub. Date: Mar. 8, 2018

(54) LOW GLOSS HOUSING ASSEMBLY FOR A DRIVER ASSIST SYSTEM CAMERA

(71) Applicant: TRW AUTOMOTIVE U.S. LLC, Livonia, MI (US)

(72) Inventor: Michael A. Hart, Dexter, MI (US)

(21) Appl. No.: 15/548,980

(22) PCT Filed: Mar. 14, 2016
(86) PCT No.: PCT/US16/22294

§ 371 Date: Aug. 4, 2017

Related U.S. Application Data
(60) Provisional application No. 62/132,065, filed on Mar. 12, 2015.

(51) Int. Cl. H04N 5/225; B60R 11/04; G02B 1/11

(52) U.S. Cl. CPC H04N 5/2252; B60R 11/04; B60R 2011/0026; G02B 1/11; H04N 5/2253

(57) ABSTRACT

A low gloss housing arrangement for use with a driver assistance system is provided to reduce glare into a camera of the system. In accordance with the present invention, a low gloss panel is secured to the area near the camera lens. Alternatively, a low gloss material is overmolded onto surfaces near the camera lens.

### RELATED APPLICATIONS

This application claims priority from U.S. Provisional Application No. 62/132,065, filed Mar. 12, 2015, the entirety of which is incorporated herein by reference.

### TECHNICAL FIELD

The present invention is directed to a driver assist system (“DAS”) and, in particular, to a low gloss housing assembly for use with a driver assistance system camera.

### BACKGROUND

Drive assist systems for vehicles are known. One particular type of DAS uses a forward facing camera. The camera is mounted in a camera housing that is secured to the front windshield of the vehicle and has a forward looking field of view in front of the vehicle. Such forward facing DAS arrangements monitor the vehicle's forward operating environment and provides other vehicle systems with the monitored environment information to aid in a safer operation of the vehicle. For example, the DAS can monitor for a potential vehicle collision condition, a lane or roadway departure occurrence, road sign information, pedestrian information, traffic information, etc.

A DAS controller located within the camera housing is connected to an output of the camera and analyzes the images output data from the camera. The controller, in response to the image data, interacts with other vehicle systems which, in turn, provide the vehicle operator with, for example, a warning, haptic/tactile feedback, autonomous vehicle operational control, etc.

To ensure that the camera of the DAS accurately perceives the environment within its field of view, it is important to reduce glare caused by sunlight or other external light sources that could affect the camera image resulting in an improper image analysis.

### SUMMARY OF THE INVENTION

The present invention provides a low gloss housing arrangement for use with a driver assistance system to reduce glare into a camera of the system. In accordance with the present invention, a low gloss panel is secured to the area near the camera lens. Alternatively, a low gloss material is overmolded onto surfaces near the camera lens.

In accordance with one example embodiment of the present invention, a housing has a main body portion and a mounting face. The mounting face has a camera viewing opening defined by at least one wall. The at least wall is covered by a panel having a gloss level of less than 1.0 gloss units. Alternatively, a low gloss material having a gloss level of less than 1.0 gloss units is overmolded on the at least one wall.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a perspective view of a driver assist system made in accordance with one example embodiment of the present invention;

FIG. 2 is an exploded view of the driver assist system of FIG. 1;

FIG. 3 is a side view of the driver assist system of FIG. 1 shown secured to a windshield of a vehicle; and

FIG. 4 is a perspective view of a driver assist system made in accordance with another example embodiment of the present invention.

### DETAILED DESCRIPTION

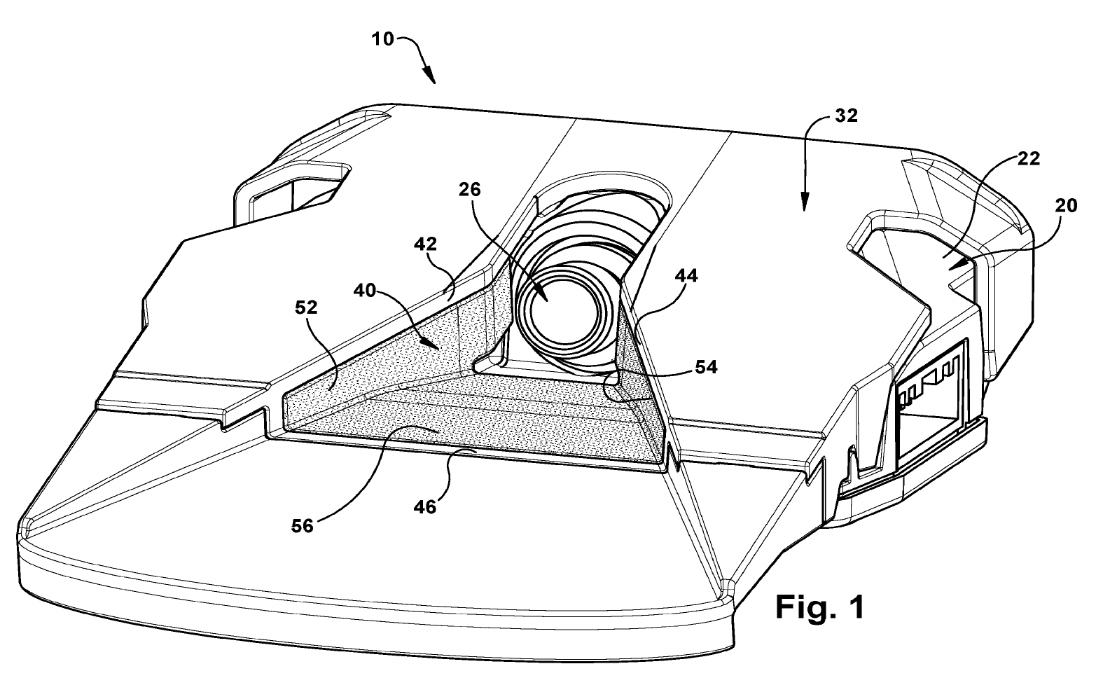

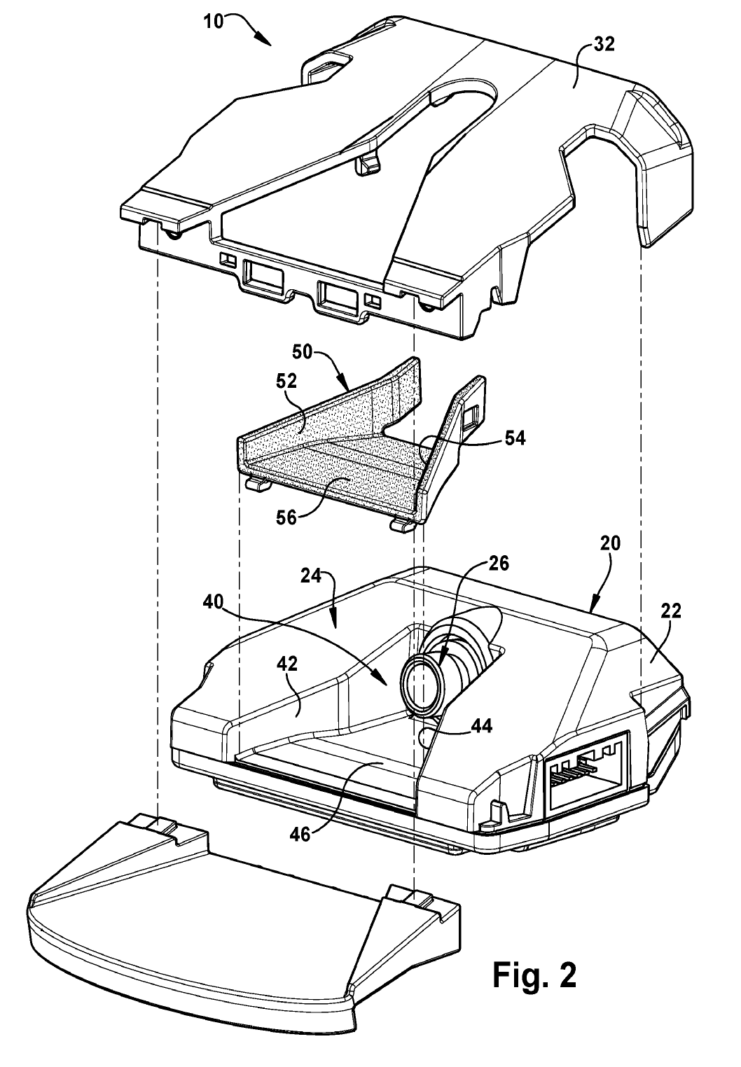

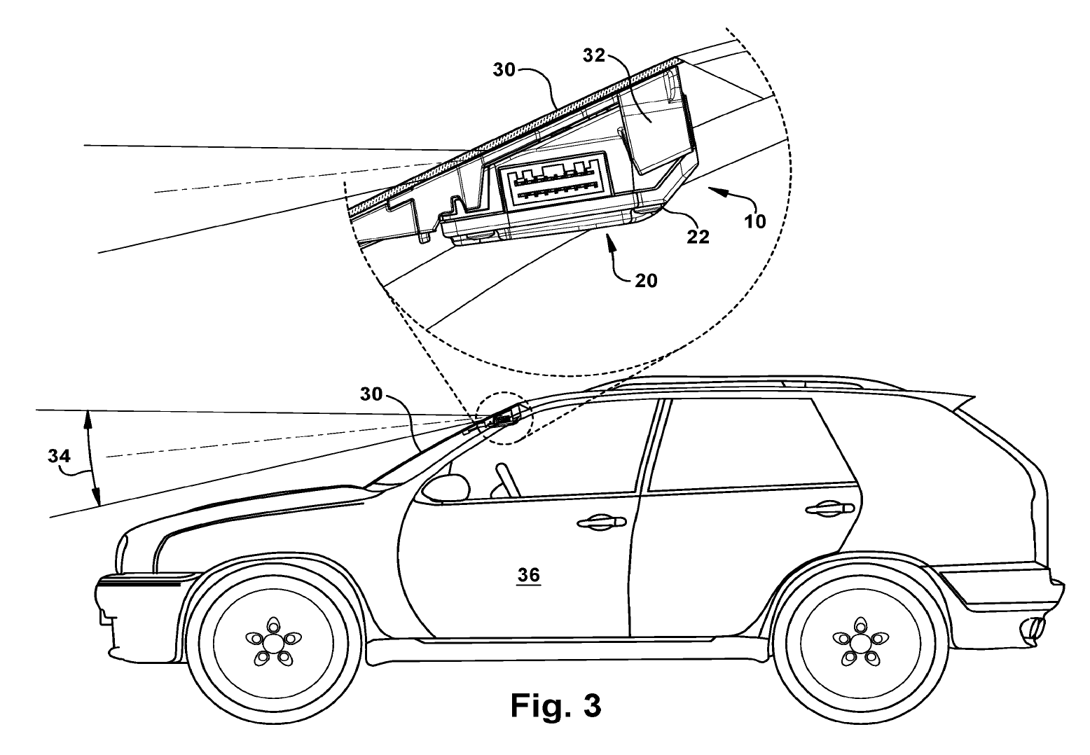

Referring to FIGS. 1-3, a driver assist system (“DAS”) 10, in accordance with a first example embodiment of the present invention, includes housing 20. The housing 20 has a main body portion 22 having a mounting face 24. A camera 26 is mounted within the main body portion 22 of the housing 20 having a lens extending out from the main body portion 22. When attached to a windshield 30 as is shown in FIG. 3 using an associated mounting bracket 32, the mounting face 24 lies substantially parallel to the windshield 30 with, in this example, the camera 26 having a forward facing field of view 34 relative to the front of the vehicle 36.

The housing 20 includes a camera viewing window or opening 40 in the mounting face 24 defined by at least one wall. The camera viewing window or opening 40 is defined by spaced apart sidewalls 42, 44 that extend away from the mounting face 24 toward a bottom wall 46 of the camera viewing opening. The bottom wall 46 interconnects and extends between the sidewalls 42, 44. When housing 20 is mounted to the vehicle windshield 30 via the mounting bracket 32, the viewing lens of camera 26 is facing forward toward the windshield 30 and, as mentioned, has a forward field of view 34 of the area in front of the vehicle. Even though the present invention is described with reference to a DAS having a forward looking camera arrangement, those skilled in the art will appreciate that the present invention is applicable to any camera based DAS arrangement having a different field of view such as a rearward facing camera arrangement or a side-ward facing camera arrangement.

In accordance with one example embodiment of the present invention, a low gloss camera shield 50 having side wall panels 52, 54 interconnected by a bottom wall panel 56 is adapted to be mounted within the camera viewing window or opening 40. Specifically, the side wall panels 52, 54 are attached to the sidewalls 42, 44, respectively and the bottom wall panel 56 is attached to the bottom wall 46. In accordance with one exemplary embodiment, the camera shield 50 is a one piece unit having appropriate snap connectors that are received in associated openings in the main body portion 22 so that the camera shield 50 is securely held in the viewing window 40. It will be appreciated that any other suitable attachment means may be employed such as gluing. Also, it will be appreciated that the panels 52, 54, 56 of the camera shield 50 could be separate panels each separately attachable to the main body portion 22 within the viewing window 40. The low gloss panels 52, 54, 56 are shaped to substantially mirror the shape of the respective wall portions 42, 44, 46 to which each panel 52, 54, 56 is attached.

The panels 52, 54, 56 of the camera shield 50 are made from a material that resists or attenuates light reflection. Alternatively, the inner surfaces of the panels 52, 54, 56 of the shield 50 could be coated with suitable non-glare material prior to installation in the viewing window 40. In accordance with one example embodiment, the surface of the panels 52, 54, 56 adjacent the camera's field of view have a gloss level of less than 1.0 gloss units. The panels could be made from rubber, silicone, or thermoplastic, or could be any material that is coated with low gloss paint as long as the gloss level is less than 1.0 gloss units. The camera shield 50 prevents light from reflecting off the walls 42, 44, 46 thereby ensuring that the image of the environment viewed by the camera 26 is not negatively affected by glare that could occur from the sun, on-coming head lights, etc.

As mentioned, the side panels 52, 54, 56 could be one single snap-in unit 50 or could be three separate panels individually snapped into their associated side walls.

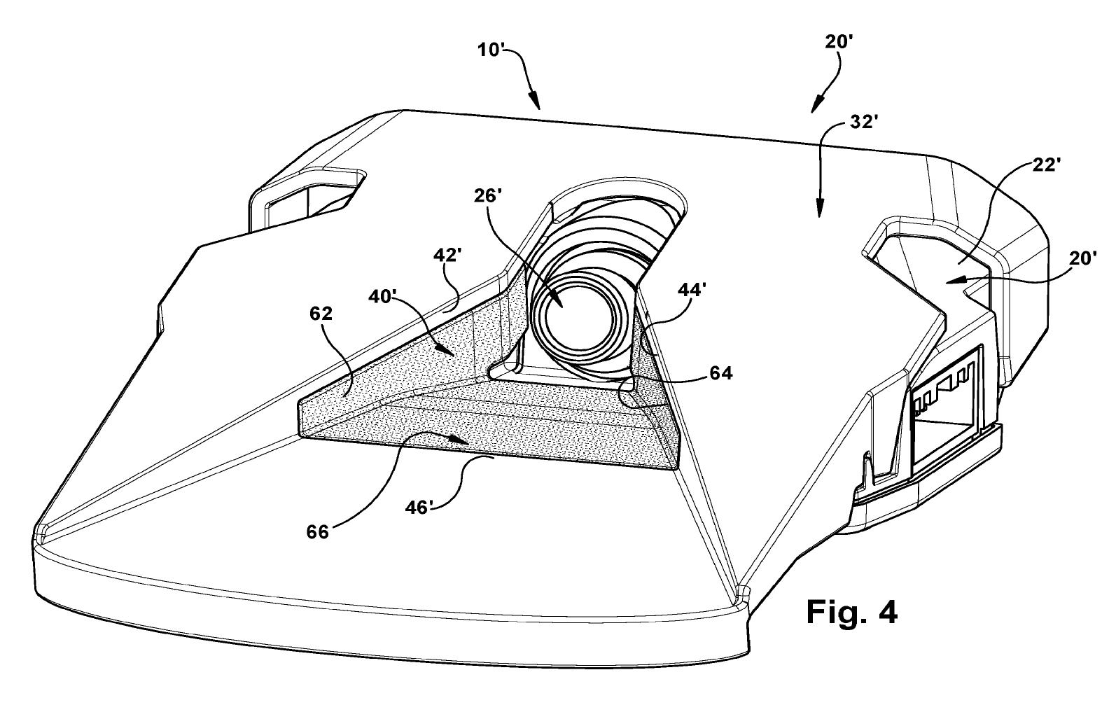

Referring to FIG. 4, a DAS, in accordance with another example embodiment is shown. A housing 20′ is substantially similar to housing 20 of the first example embodiment, with similar reference numerals denoting similar features and designated with a prime. The housing 20′ is provided with overmolded material having low gloss surfaces 62, 64, 66 instead of a separate camera shield 50 with separate low gloss panels 52, 54, 56 of the embodiment shown in FIG. 1. The material forming surfaces 62, 64, 66 are overmolded onto the side walls 40′, 44′, 46′, respectively, using an appropriate low gloss material that can be overmolded. Any other suitable overmolding material having a gloss level less than 1.0 gloss units may be used.

From the above description of the invention, those skilled in the art will perceive improvements, changes and modifications. Such improvements, changes and modifications within the skill of the art are intended to be covered by the appended claims.

Having described the invention, the following is claimed:

1. A housing for a vehicle driver assistance system comprising:
a main body portion and a mounting face, the mounting face having a viewing window defined by at least one wall;
a camera provided in the main body portion adjacent the at least one wall and having a field of view outside of the vehicle; and
at least one panel having a gloss level of less than 1.0 gloss units attached to the at least one wall to reduce glare for the camera.

2. A housing for a vehicle driver assistance system as set forth in claim 1 wherein the viewing window is defined by spaced apart sidewalls that extend away from the mounting face toward a bottom wall of the viewing opening, the bottom wall interconnecting and extending between the sidewalls.

3. A housing for a vehicle driver assistance system as set forth in claim 2 wherein a low gloss camera shield having side wall panels interconnected by a bottom wall panel is mounted within the viewing window.

4. A housing for a vehicle driver assistance system as set forth in claim 3 wherein the side wall panels of the low gloss camera shield are attached to the sidewalls defining the viewing window and the bottom wall panel of the low gloss camera shield is attached to the bottom wall of the viewing opening.

5. A housing for a vehicle driver assistance system as set forth in claim 3 wherein the camera shield is a one piece unit.

6. A housing for a vehicle driver assistance system as set forth in claim 3 wherein the side wall panels and bottom wall panel of the camera shield are separate panels each separately attachable to the main body portion within the viewing window.

7. A housing for a vehicle driver assistance system as set forth in claim 1 wherein the at least one panel has a snap connector that is received in an opening in the main body portion.

8. A housing for a vehicle driver assistance system as set forth in claim 1 wherein the at least one panel is made from a material that resists or attenuates light reflection.

9. A housing for a vehicle driver assistance system as set forth in claim 1 wherein an inner surface of the at least one panel is coated with suitable non-glare material.

10. A housing for a vehicle driver assistance system comprising:
a main body portion and a mounting face, the mounting face having a viewing window defined by at least one wall; and
a camera provided in the main body portion adjacent the at least one wall and having a field of view outside of the vehicle;
wherein the at least one wall is overmolded with a material having a gloss level of less than 1.0 gloss units to reduce glare for the camera.

11. A housing for a vehicle driver assistance system as set forth in claim 1 wherein the viewing window is defined by spaced apart sidewalls that extend away from the mounting face toward a bottom wall of the viewing opening, the bottom wall interconnecting and extending between the sidewalls.

12. A housing for a vehicle driver assistance system as set forth in claim 11 wherein the sidewalls defining the viewing window and the bottom wall are overmolded with the material having the gloss level less than 1.0 gloss units.
